(19) United States
(12) Patent Application Publication
(10) Pub. No.: US 2026/0041042 A1
(43) Pub. Date: Feb. 12, 2026

(54) TOWING VEHICLE/BALER COMBINATION, BALER, AND METHOD FOR OPERATING A COMBINATION OR BALER

(71) Applicant: DEERE & COMPANY, MOLINE, IL (US)

(72) Inventor: ALEXIS FILLOUX, GRAY (FR)

(21) Appl. No.: 19/097,350

(22) Filed: Apr. 1, 2025

(30) Foreign Application Priority Data
Aug. 9, 2024 (EP) 24193778.8

(51) Int. Cl. A01F 15/08; A01F 15/07; A01F 15/10; A01F 15/18

(52) U.S. Cl. CPC A01F 15/0833; A01F 15/0715; A01F 15/10; A01F 2015/076; A01F 2015/077; A01F 15/0875; A01F 15/18

(57) ABSTRACT

A combination of a tow vehicle and a baler includes a pick-up unit for picking up a crop from the ground and for feeding the crop into a baling unit, which compresses the crop into a bale. The combination includes a control unit and a sensor for capturing an acoustic signal. The control unit is configured to characterize the picking-up of the crop and the compressing of the bale on the basis of a sensor signal from the sensor indicative of the acoustic signal of the baler. The control unit may then control the tow vehicle and/or the baler based on the characterization of the sensor signal.

### CROSS-REFERENCE TO RELATED APPLICATIONS

This application claims the benefit of European Patent Application No. EP24193778.8, filed on Aug. 9, 2024, the disclosure of which is hereby incorporated by reference

### TECHNICAL FIELD

The disclosure generally relates to a baler and a combination of a towing vehicle and a baler, and a method of operating the same.

### BACKGROUND

Balers, in particular round balers or square balers, are used to pick up and compress a crop, for example straw, hay, or the like. For this purpose, the baler can comprise a pick-up unit for picking up the crop, in particular for picking up the crop from a swath. In this instance, the crop lying on the ground can be picked up by means of the pick-up unit, in particular a pick-up. The baler can also comprise a baling unit, in particular a baling chamber. The baling unit, in particular the baling chamber, can comprise one or more baling means. The baling unit can receive the crop picked up by the pick-up unit and compress it into a bale. The baler can moreover comprise a conveying unit. The crop which is picked up by the pick-up unit can be cut by means of the conveying unit, for example, a rotor and/or an underfloor with blades, and directed into the baling unit. The conveying unit can be designed as part of the pick-up unit or be arranged downstream of the pick-up unit, in particular arranged downstream in the conveying direction. The bale, in particular the round bale or the square bale, is shaped in the baling unit. Once shaped, the bale can then be wrapped in the baling unit with a wrapping material, for example a mesh, film, or twine. Once the bale has been shaped or completely wrapped, it can be discharged or ejected by an ejection unit, for example, an ejection flap or a rear part or a rear flap of the baler, being moved into an open position, and optionally via a ramp or in particular an ejector.

The baler can be part of a combination with a towing vehicle. The baler can be connected to the towing vehicle. Moreover, the towing vehicle can pull the baler and/or drive it with an energy and/or a force and/or a torque and/or a rotational speed. The energy and/or force and/or the torque and/or the rotational speed can be transmittable and/or distributable from the towing vehicle to the baler, in particular to the baling unit and/or the pick-up unit.

A disadvantage of the known balers or combinations is that the picking-up of the crop and/or the compressing of the bale and/or an overload situation, for example a blockage, of the baling unit and/or pick-up unit can be identified only with difficulty or too late automatically and/or by an operator.

### SUMMARY

The present disclosure is therefore based on the object of proposing a combination of a towing vehicle and a baler, and a method of operating the combination and/or the baler, by means of which the aforementioned problems are overcome. In particular, a baler, a combination of the towing vehicle and the baler, and a method of operating the combination or the baler is proposed which make it possible to identify the picking-up of the crop and/or the compressing of the bale and/or an overload situation and/or to allow the operator to avoid an overload situation.

The disclosure provides a baler and a combination of a towing vehicle and the baler (or combination). The combination includes the towing vehicle and the baler. The baler includes a pick-up unit for picking up a crop from the ground and for feeding the crop into a baling unit, and the baling unit for receiving the crop from the pick-up unit and for compressing a bale. The combination further comprises a control unit and a sensor for capturing an acoustic signal, wherein the control unit is connected to the sensor. The control unit is configured to characterize the picking-up of the crop, in particular by the pick-up unit and/or baling unit, and the compressing of the bale on the basis of a sensor signal of the sensor.

The sensor can thus identify, preferably capture and/or detect, the acoustic signal, in particular an acoustic signal emitted in or from the baler, preferably in or from the baling unit and/or the pick-up unit. The baling process can comprise in particular the picking-up of the crop from the ground by the pickup unit and the feeding of the crop into the baling unit by the pick-up unit and/or the receipt of the crop by the baling unit and/or the compressing of the bale by the baling unit. Specifically, the acoustic signal can be identified, preferably captured and/or detected, by means of the sensor during the baling process. The sensor can be configured to provide a sensor signal which comprises acoustic information about the acoustic signal which is emitted in the baler, in particular of the baling process. The acoustic signal, in particular the emitted acoustic signal, can comprise, for example, sound components which are caused by the picking-up of the crop from the ground by the pick-up unit, and feeding of the crop into the baling unit by the pick-up unit, and/or receipt of the crop by the baling unit, and/or compressing of the bale by the baling unit, in particular vibration of the baler and/or the baling unit and/or the pick-up unit during these work steps. In other words, one or more acoustic signals, in particular acoustic signals emitted in the baler, can be capturable by means of the sensor in the form of a sensor signal. The sensor is connected to the control unit by signals, and/or operatively coupled thereto and/or connected thereto for transmitting signals and/or carrying data. The sensor signal can consequently be sent by the sensor to the control unit and/or received by the control unit. The sensor can capture the acoustic signal and provide it in the form of an electrical sensor signal.

The baler can be a square baler for forming square bales, or a round baler for forming round bales from a crop. The baler can comprise a baler frame. The baler can also be integrated into a towing vehicle, i.e. the baler can be designed as a self-propelling baler. The baler can be supported on the ground by wheels. The baling unit, in particular the baling chamber, can comprise one or more baling means. The baler can moreover comprise a conveying unit. The bale can be shaped by means of the baling unit, in particular in a compressing phase. The baler can comprise the pick-up unit, in particular a pick-up, for picking up a crop from the ground and in particular for picking up the crop of a swath.

The baler can comprise an ejection unit, for example an ejection flap or a rear part or a rear flap of the baler. Once it has been shaped or wrapped, the bale can be discharged or ejected when the ejection unit is in the second position, i.e. the baling unit is open. The ejection unit can be arranged pivotably on the baler, in particular on the baler frame or on a housing part, preferably connected thereto and/or fastened thereto and/or carried thereon, particularly preferably being pivotably mounted thereon. The baler can be designed with a variable-size baling unit, in particular baling chamber, or as a baler with a variable baling unit, in particular baling chamber. The baler with a variable-size baling unit can comprise one or more baling means, wherein the baling means can be, in particular, in the form of a belt or strap or chain assembly or band. The baler can likewise also comprise an invariable-size baling unit. The baling means can here be designed as one or more baling rollers. The baling rollers can be arranged so that they run parallel to one another for compressing the crop. The axes of rotation of the baling rollers can lie on an arc in the case of a closed ejection unit, and at least one of the baling rollers can be driven. The arrangement of the baling rollers in the baling unit can correspond to a cylindrical shape, such that the baling rollers are arranged cylindrically about the round bale and form a cylindrical circumferential surface. The baling unit can be arranged on the baler frame, preferably connected thereto and/or fastened thereto. The pick-up unit for picking up or for collecting a crop lying in a field, i.e. on the ground, and/or for conveying the crop into the baling unit, can likewise be arranged on the baler frame, preferably connected thereto and/or fastened thereto.

The control unit can in particular be designed as an integrated and/or common control unit of the combination. The control unit can be arranged on, at, or in the combination, in particular the towing vehicle or the baler. Alternatively or additionally, the control unit can be designed as the towing vehicle control unit and the baler control unit. The control unit can comprise the baler control unit and the towing vehicle control unit. The towing vehicle control unit can be connected to the baler control unit, in particular connected by signals and/or operatively coupled and/or connected for transmitting signals and/or carrying data, and/or is activatable and/or settable and/or adjustable. In this case, the baler control unit can be arranged on, at, or in the baler and the towing vehicle control unit can be arranged on, at, or in the towing vehicle and/or be assigned to it. The control unit can be arranged on or at or in the towing vehicle or the baler.

The baler can comprise the baler control unit (instead of the control unit). The baler control unit can be arranged at or on or in the baler. The baler control unit can be connected to the pick-up unit and the baling unit, connected by signals and/or operatively coupled and/or connected for transmitting signals and/or carrying data (instead of to the control unit). The towing vehicle can comprise the towing vehicle control unit (instead of the control unit). The towing vehicle control unit can be arranged, in particular be fastened or fastenable, at or on or in the towing vehicle.

Mechanically connected can be understood as meaning in particular drivably connected and/or coupled or couplable, or mechanically coupled or mechanically couplable. Mechanically connected, preferably drivably connected and/or coupled or couplable, or mechanically coupled or mechanically couplable, can specifically therefore be understood as meaning a connection of two components which makes it possible to transmit an energy and/or a force and/or a torque and/or a rotational speed from one component to the other, in particular mechanically. Further components or parts enabling such a transmission of energy and/or force and/or torque and/or transmission of a rotational speed between the two components can be provided here between the two components.

The baler can be mechanically connected to the towing vehicle. The baler can be coupled to the towing vehicle; for example, the combination can comprise the towing vehicle and the baler pulled by the towing vehicle by means of a drawbar. The towing vehicle can be an agricultural towing vehicle, in particular a tractor or a hauler. The towing vehicle can be arranged in front of the baler in a direction of travel. The towing vehicle can pull the baler. The towing vehicle can comprise a drive train. The drive train may comprise a motor and/or a transmission unit to drive the towing vehicle/baler combination. The towing vehicle can moreover comprise one or more auxiliary units, for example a pump and/or a radiator, etc. The baler can be mechanically connected to the towing vehicle via the input shaft and/or via a towing device, for example the drawbar and/or a coupling. For example, a towing vehicle frame of the towing vehicle can be connected to a baler frame of the baler via or by means of the towing device. The towing vehicle can comprise the towing vehicle frame. The drive train can be arranged and/or fastened on the towing vehicle frame, in particular can also be supported by the towing vehicle frame. The towing vehicle can comprise the ground engagement means. The ground engagement means can support and/or carry the towing vehicle on the ground. The towing vehicle frame of the towing vehicle can be supported on front and rear wheels. The ground engagement means can be wheels or tracks or chains. The ground engagement means, in particular the front wheels and rear wheels, can be steerable and/or movable.

The combination, in particular the towing vehicle, can comprise an input and output unit. The baler control unit and/or the towing vehicle control unit or the control unit can be connected to the input and output unit, in particular connected by signals and/or operatively coupled and/or connected for transmitting signals and/or carrying data, and/or can be activatable and/or settable and/or adjustable. The input and output unit can be integrated into the baler control unit and/or the towing vehicle control unit or the control unit, or vice versa.

Moreover, the towing vehicle can comprise the control unit or the towing vehicle control unit. The towing vehicle control unit or the control unit can be connected to a drive train, in particular to the motor and/or the transmission unit or the transmission, and/or to a PTO unit, connected by signals and/or operatively coupled and/or connected for transmitting signals and/or carrying data. The combination, in particular the towing vehicle, can comprise a speed sensor for capturing a speed of the towing vehicle.

The towing vehicle control unit or the control unit can be configured to set and/or adjust and/or activate the drive train, in particular the motor and/or the transmission unit or the transmission, and/or the PTO unit, for example by the towing vehicle control unit or the control unit setting and/or adjusting and/or activating valves and/or actuators of these components. The towing vehicle control unit or the control unit can be configured to set and/or adjust and/or activate an energy and/or a force and/or a torque and/or a rotational speed of the motor and/or the PTO unit.

The baler can comprise a wrapping installation for wrapping the bale, in particular the finished shaped bale, with a wrapping material. The wrapping material can be, for example, mesh, film, or twine. Once it has been shaped, the bale can be wrapped with the wrapping material in or during a wrapping process, in particular in the baling unit.

The control unit may be configured to characterize the baling process, in particular the picking-up of the crop and/or the compressing of the crop, on the basis of one or more sensor signals of the sensor. In other words, the combination, in particular the baler, can be operatable by means of the control unit in such a way that it can characterize the baling process by means of or on the basis of the sensor signal. The term “characterize” can be understood in this case to mean that, for example, the baling process can be identified, in particular captured and/or processed, in terms of quality and/or quantity and/or the progression of the baling process can be identified, in particular captured and/or processed on the basis of the sensor signal, in particular the sensor signal or the sensor signals as a function of time. It is consequently advantageously possible to identify the baling process in a structurally less complex manner because only one sensor is required to capture the sound in order to characterize the baling process. It is furthermore advantageous that it is possible to identify in a technically simple manner whether and how the baling process took place.

In one implementation of the disclosure, the control unit is configured to identify an amplitude and/or a frequency of the sensor signal and to characterize the picking-up of the crop and/or the compressing of the bale with or on the basis of the amplitude and/or the frequency. To this end, the amplitude and/or frequency of the acoustic signal can be identified, in particular calculated and/or analyzed, in particular on the basis of the amplitude and/or frequency of the sensor signal. Likewise, the control unit can be configured to compare the amplitude and/or frequency of the sensor signal with one or more threshold values, in particular an amplitude and/or frequency threshold value, and to identify whether the amplitude and/or frequency is/are above or below the threshold value or values or is/are equal to the threshold value or values.

Specifically, a first phase of the baling process can exist when the amplitude of the sensor signal is less than or in particular equal to the amplitude threshold value and/or the frequency of the sensor signal is less than or in particular equal to the frequency threshold value, i.e. when

$$A < {A}_{threshold} and / or θ < {θ}_{threshold}$$

Wherein A=amplitude of the sensor signal and A_{threshold}=amplitude threshold value, or wherein θ=frequency of the sensor signal and θ_{threshold}=frequency threshold value.

A transition point from the picking-up of the crop to the compressing of the crop can exist when A<A_{threshold} and/or θ<θ_{threshold}. In this case, the first or a second phase can exist.

A second phase can exist when the amplitude of the sensor signal is greater than the amplitude threshold value and/or the frequency of the sensor signal is greater than the frequency threshold value, i.e. when

$$A < {A}_{threshold} and / or θ < {θ}_{threshold}$$

The first phase can comprise the picking-up of the crop from the ground by the pick-up unit and the feeding of the crop into the baling unit by the pick-up unit and/or the receipt of the crop by the baling unit. The second phase can comprise the compressing of the bale by the baling unit. It is, however, conversely also possible that the first phase comprises the compressing of the bale by the baling unit and the second phase comprises the picking-up of the crop from the ground by the pick-up unit, and the feeding of the crop into the baling unit by the pick-up unit and/or the receipt of the crop by the baling unit. The baling process can advantageously be characterized and/or identified on the basis of the amplitude and/or frequency of the sensor signal.

In one implementation of the disclosure, the acoustic signal or signals is/are capturable as a function of time. The control unit can be configured to characterize the picking-up of the crop and/or the compressing of the bale, i.e. the baling process, on the basis of a sensor signal or a plurality of sensor signals of the sensor as a function of time. Furthermore, the control unit can be configured to identify one or more amplitudes and/or frequencies of the sensor signal or signals as a function of time and/or to compare the amplitudes and/or frequencies of the sensor signals as a function of time with the threshold value or values, in particular the amplitude and/or frequency threshold value. As a result of capturing the acoustic signal as a function of time, the characterization of the baling process, in particular the progression, can be assessed by means of the sensor signal and/or the quality and quantity of the baling process can be assessed by means of the amplitudes and/or frequencies.

In one implementation of the disclosure, the control unit is configured to filter and/or process the sensor signal. In this case, the amplitude or amplitudes and/or frequency or frequencies can be changed and/or processed by means of filters. Specifically, the sensor signal, in particular the sensor signal or signals as a function of time, can be processed with a Fourier transform and/or a high-pass filter and/or low-pass filter can be applied to the signals or the Fourier transform thereof. The amplitude or amplitudes and/or frequency or frequencies can consequently be identified in a simple manner on the basis of the sensor signal or signals, in particular the sensor signals as a function of time.

In one implementation of the disclosure, the control unit is configured to generate and/or send a pick-up signal and/or a compressing signal as a function of the sensor signal, in particular of the amplitude and/or the frequency. The control unit can be configured to generate and/or send the pickup signal when the amplitude and/or frequency of the sensor signal is less than or greater than the threshold value or values, and/or to generate and/or send the compressing signal when the amplitude and/or frequency of the sensor signal is less than or greater than the threshold value or values. Specifically, the control unit can be configured to generate and send a pick-up signal when a first phase of the baling process is identified, in particular when the amplitude of the sensor signal is less than or in particular equal to the amplitude threshold value and/or the frequency of the sensor signal is less than or in particular equal to the frequency threshold value, i.e. when

$$A < {A}_{threshold} and / or θ < {θ}_{threshold}$$

Alternatively or additionally, the control unit can be configured to generate and send a pick-up signal or a compressing signal when a transition point is identified, in particular when A=A_{threshold} and/or θ=θ_{threshold}. Alternatively or additionally, the control unit can be configured to generate and send a compressing signal when a second phase is identified, in particular when the amplitude of the sensor signal is greater than the amplitude threshold value and/or the frequency of the sensor signal is greater than the frequency threshold value, i.e. when

$$A > {A}_{threshold} and / or θ > {θ}_{threshold}$$

It is, however, conversely also possible that the control unit is configured to generate and send a compressing signal when a first phase of the baling process is identified, in particular when the amplitude of the sensor signal is less than or in particular equal to the amplitude threshold value and/or the frequency of the sensor signal is less than or in particular equal to the frequency threshold value, i.e. when

$$A < {A}_{threshold} and / or θ < {θ}_{threshold} .$$

Alternatively or additionally, the control unit can be configured to generate and send the pick-up signal or a compressing signal when a transition point is identified, in particular when A=A_{threshold} and/or θ=θ_{threshold}. Alternatively or additionally, the control unit can be configured to generate and send a pick-up signal when a second phase is identified, in particular when the amplitude of the sensor signal is greater than the amplitude threshold value and/or the frequency of the sensor signal is greater than the frequency threshold value, i.e. when:

$$A > {A}_{threshold} and / or θ > {θ}_{threshold}$$

The control unit can send the compressing signal and/or the pickup signal to the input and output unit. The input and output unit can signal to and/or inform the operator of the combination by means of the compressing signal that the baler, in particular the baling unit, is compressing the bale. The input and output unit can signal to and/or inform the operator of the combination by means of the pick-up signal that the baler, in particular the baling unit, is picking up the crop. The status of the baling process can advantageously be indicated to the operator of the combination by means of the compressing signal and the pick-up signal.

In one implementation of the disclosure, the control unit is configured to generate and/or send a driving signal and/or a control signal as a function of the sensor signal, in particular as a function of the amplitude and/or frequency. The control unit can be configured to generate and/or send the driving signal when the amplitude and/or frequency of the sensor signal is less than or greater than the threshold value or values, and/or to generate and/or send the control signal when the amplitude and/or frequency of the sensor signal is less than or greater than the threshold value or values. Specifically, the control unit can be configured to generate and send the driving signal and/or the control signal when a first phase of the baling process is identified, in particular when the amplitude of the sensor signal is less than or in particular equal to the amplitude threshold value and/or the frequency of the sensor signal is less than or in particular equal to the frequency threshold value, i.e. when:

$$A < {A}_{threshold} and / or θ < {θ}_{threshold}$$

Alternatively or additionally, the control unit can be configured to generate and send the driving signal and/or the control signal when a transition point is identified, in particular when A=A_{threshold} and/or θ=θ_{threshold}.

It is, however, conversely also possible that the control unit is configured to generate and send the driving signal and/or the control signal when a second phase is identified, in particular when the amplitude of the sensor signal is greater than the amplitude threshold value and/or the frequency of the sensor signal is greater than the frequency threshold value, i.e. when:

$$A > {A}_{threshold} and / or θ > {θ}_{threshold}$$

Alternatively or additionally, the control unit can be configured to generate and send the driving signal or the control signal when a transition point is identified, in particular when A=A_{threshold} and/or θ=θ_{threshold}. The control unit can send the driving signal to the input and output unit. The input and output unit can signal to and/or inform the operator of the combination by means of the driving signal to set and/or adjust the speed of the combination or the towing vehicle, in particular a rotational speed or a torque or an energy of the drive train. The control unit can send the control signal to the input and output unit. The input and output unit can signal to and/or inform the operator of the combination by means of the control signal to set and/or adjust the PTO unit, in particular a rotational speed or a torque or an energy of the PTO unit.

In one implementation of the disclosure, the towing vehicle comprises the drive train for driving the towing vehicle and/or the PTO unit. The control unit or the towing vehicle control unit is connected to the drive train and/or the PTO unit. Moreover, the control unit or the towing vehicle control unit is configured to set and/or adjust the drive train, in particular a speed of the combination, by means of the driving signal and/or to set and/or adjust the PTO unit by means of the control signal.

The drive train can comprise the motor and/or the transmission unit or the transmission. The motor and/or the transmission unit or the transmission can be mechanically connected. The towing vehicle can comprise the PTO unit, in particular a PTO transmission and/or a PTO shaft or output shaft. The PTO unit can comprise a PTO transmission and/or the PTO shaft or output shaft. The drive train, in particular the motor and/or the transmission unit or the transmission can drive the PTO unit, in particular the PTO transmission and/or the PTO shaft. The drive train can be mechanically connected to the PTO transmission and/or the PTO shaft. The PTO unit can moreover be mechanically connected, for example by means of a drive shaft, to the baler in order to drive the baling unit and the pick-up unit. Alternatively, the towing vehicle control unit can perform the tasks of the control unit.

The control unit or the towing vehicle control unit can be connected to the drive train, in particular the motor and/or the transmission unit or the transmission, preferably connected by signals and/or operatively coupled and/or connected for transmitting signals and/or carrying data. For this purpose, the control unit can be connected, for example, to valves or actuators of the motor or the transmission unit or the transmission, preferably connected by signals and/or operatively coupled and/or connected for transmitting signals and/or carrying data. The speed of the combination or the towing vehicle can be changed by means of the driving signal by increasing or reducing an energy and/or a force and/or a torque and/or a rotational speed of the drive train, in particular the motor. Additionally or alternatively, a gear of the transmission unit or the transmission, in particular a gear ratio, can be set and/or adjusted. The speed can be adapted automatically or by an operator of the combination. The motor can be, for example, an internal combustion engine or an electric motor. The transmission unit can comprise the transmission.

The control unit or the towing vehicle control unit can be configured to set and/or adjust, in particular to increase or reduce, the motor and/or the transmission unit or the transmission by means of or as a function of the driving signal. The control unit or the towing vehicle control unit can be configured to set and/or adjust, in particular to increase or reduce, the energy and/or the torque and/or the force and/or the rotational speed of the drive train, in particular of the motor and/or the transmission unit or the transmission, by means of or as a function of the driving signal.

Specifically, the control unit or the towing vehicle control unit can be configured to reduce or decrease the energy and/or the torque and/or the force and/or the rotational speed of the drive train, in particular of the motor and/or the transmission unit or the transmission, by means of or as a function of the driving signal, when a first phase is identified, in particular when the amplitude of the sensor signal is less than or in particular equal to the amplitude threshold value and/or the frequency of the sensor signal is less than or in particular equal to the frequency threshold value, i.e. when:

$$A < {A}_{threshold} and / or θ < {θ}_{threshold}$$

Alternatively or additionally, the control unit or the towing vehicle control unit can be configured to reduce or decrease the energy and/or the torque and/or the force and/or the rotational speed of the drive train, in particular of the motor and/or the transmission unit or the transmission, by means of or as a function of the driving signal, when a transition point is identified, in particular when A=A_{threshold} and/or θ=θ_{threshold}. Alternatively, the control unit or the towing vehicle control unit can be configured to increase the energy and/or the torque and/or the force and/or the rotational speed of the drive train, in particular of the motor and/or the transmission unit or the transmission, by means of or as a function of the driving signal, when a transition point is identified, in particular when A=A_{threshold} and/or θ=θ_{threshold}. Alternatively or additionally, the control unit can be configured to increase the energy and/or the torque and/or the force and/or the rotational speed of the drive train, in particular of the motor and/or the transmission unit or the transmission, by means of or as a function of the driving signal, when a second phase is identified, in particular when the amplitude of the sensor signal is greater than the amplitude threshold value and/or the frequency of the sensor signal is greater than the frequency threshold value, i.e. when:

$$A > {A}_{threshold} and / or θ > {θ}_{threshold}$$

It is, however, conversely also possible that the control unit is configured to increase the energy and/or the torque and/or the force and/or the rotational speed of the drive train, in particular of the motor and/or the transmission unit or the transmission, when a first phase of the baling process is identified, in particular when the amplitude of the sensor signal is less than or in particular equal to the amplitude threshold value and/or the frequency of the sensor signal is less than or in particular equal to the frequency threshold value, i.e. when:

$$A < {A}_{threshold} and / or θ < {θ}_{threshold}$$

Alternatively or additionally, the control unit can be configured to increase the energy and/or the torque and/or the force and/or the rotational speed of the drive train, in particular of the motor and/or the transmission unit or the transmission, when a transition point is identified, in particular when A=A_{threshold} and/or θ=θ_{threshold}. Alternatively, the control unit can be configured to reduce or decrease the energy and/or the torque and/or the force and/or the rotational speed of the drive train, in particular of the motor and/or the transmission unit or the transmission, when a transition point is identified, in particular when A=A_{threshold} and/or θ=θ_{threshold}. Alternatively or additionally, the control unit can be configured to reduce or decrease the energy and/or the torque and/or the force and/or the rotational speed of the drive train, in particular of the motor and/or the transmission unit or the transmission, when a second phase is identified, in particular when the amplitude of the sensor signal is greater than the amplitude threshold value and/or the frequency of the sensor signal is greater than the frequency threshold value, i.e. when:

$$A > {A}_{threshold} and / or θ > {θ}_{threshold}$$

In other words, the control unit or the towing vehicle control unit can be configured to activate and/or set and/or adjust the drive train by means of the driving signal, and to set and/or adjust the speed of the combination, in particular the towing vehicle, from a first speed to a second speed.

The control unit or the towing vehicle control unit can be configured to set and/or adjust the PTO unit, in particular an electric motor of the PTO unit, by means of or as a function of the control signal, in particular to increase or reduce a rotational speed or a torque or an energy. The control unit or the towing vehicle control unit can be configured to set and/or adjust, in particular to increase or reduce, the energy and/or the torque and/or the force and/or the rotational speed of the PTO unit, by means of or as a function of the driving signal.

Specifically, the control unit or the towing vehicle control unit can be configured to reduce or decrease the energy and/or the torque and/or the force and/or the rotational speed of the PTO unit, by means of or as a function of the control signal, when a first phase of the baling process is identified, in particular when the amplitude of the sensor signal is less than or in particular equal to the amplitude threshold value and/or the frequency of the sensor signal is less than or in particular equal to the frequency threshold value, i.e. when:

$$A < {A}_{threshold} and / or θ < {θ}_{threshold}$$

Alternatively or additionally, the control unit or the towing vehicle control unit can be configured to reduce or decrease the energy and/or the torque and/or the force and/or the rotational speed of the PTO unit, by means of or as a function of the control signal, when a transition point is identified, in particular when A=A_{threshold} and/or θ=θ_{threshold}. Alternatively, the control unit or the towing vehicle control unit can be configured to increase the energy and/or the torque and/or the force and/or the rotational speed of the PTO unit, by means of or as a function of the control signal, when a transition point is identified, in particular when A=A_{threshold} and/or θ=θ_{threshold}. Alternatively or additionally, the control unit can be configured to increase the energy and/or the torque and/or the force and/or the rotational speed of the PTO unit, by means of or as a function of the control signal, when a second phase is identified, in particular when the amplitude of the sensor signal is greater than the amplitude threshold value and/or the frequency of the sensor signal is greater than the frequency threshold value, i.e. when:

$$A > {A}_{threshold} and / or θ > {θ}_{threshold}$$

It is, however, conversely also possible that the control unit is configured to increase the energy and/or the torque and/or the force and/or the rotational speed of the PTO unit, by means of or as a function of the control signal, when a first phase of the baling process is identified, in particular when the amplitude of the sensor signal is less than or in particular equal to the amplitude threshold value and/or the frequency of the sensor signal is less than or in particular equal to the frequency threshold value, i.e. when:

$$A < {A}_{threshold} and / or θ < {θ}_{threshold}$$

Alternatively or additionally, the control unit can be configured to increase the energy and/or the torque and/or the force and/or the rotational speed of the PTO unit, by means of or as a function of the control signal, when a transition point is identified, in particular when A=A_{threshold} and/or θ=θ_{threshold}. Alternatively, the control unit can be configured to reduce or decrease the energy and/or the torque and/or the force and/or the rotational speed of the PTO unit, by means of or as a function of the control signal, when a transition point is identified, in particular when A=A_{threshold} and/or θ=θ_{threshold}.

Alternatively or additionally, the control unit can be configured to reduce or decrease the energy and/or the torque and/or the force and/or the rotational speed of the PTO unit, by means of or as a function of the control signal, when a second phase is identified, in particular when the amplitude of the sensor signal is greater than the amplitude threshold value and/or the frequency of the sensor signal is greater than the frequency threshold value, i.e. when:

$$A > {A}_{threshold} and / or θ > {θ}_{threshold}$$

In other words, the control unit or the towing vehicle control unit can be configured to activate and/or set and/or adjust the PTO unit by means of the control signal, and to set and/or adjust the rotational speed and/or the energy and/or the torque of the PTO unit, from a first rotational speed and/or energy and/or a first torque of the PTO unit to a second rotational speed and/or energy and/or a first torque of the PTO unit. The feeding of the crop can advantageously consequently be set as a function of the acoustic signal via the speed of the combination or the rotational speed and/or the energy and/or the torque of the PTO unit.

In one implementation of the disclosure, the sensor or the sensors is or are arranged on the baling unit and/or on the pick-up unit and/or on a baler frame of the baler, preferably mechanically connected thereto or fastened thereon. The sensor can in particular be connected to or fastened on the baling unit or the pick-up unit contactlessly, i.e. without touching them. The sensor can be an acoustic sensor, in particular a microphone or an ultrasound sensor. The acoustic signal which is emitted in the baler, in particular the baling unit, can consequently be captured in a simple manner.

In one implementation of the disclosure, the control unit or the towing vehicle control unit is configured to characterize the picking-up of the crop and/or the compressing of the bale on the basis of a representative model as a function of the sensor signal of the sensor, in particular as a function of the sensor signal as a function of time. The model can here be a software representation or simulation or a function, in particular a progression of the acoustic signal, the picking-up of the crop and/or the compressing of the bale. By means of a compensation calculation, the parameters of the function can be determined or estimated. Furthermore, the control unit can be configured to identify, in particular to calculate, the amplitude or amplitudes and/or frequency or frequencies on the basis of the representative model. The control unit can further be configured to compare the amplitude or amplitudes and/or frequency or frequencies with a or the threshold value. The control unit can moreover be configured to adapt and/or to improve the model with the acoustic signals captured by the sensor, in particular as a function of time, of the wrapping process.

The disclosure furthermore provides a method of operating the combination of the tow vehicle and the baler. The method may include the steps of:
receiving the crop by means of or by the baling unit from the pick-up unit and compressing a bale in the baling unit,
capturing an acoustic signal in the baler, in particular the baling unit, by a sensor, and
characterizing the receipt of the crop by means of or by the baling unit and compressing a bale in the baling unit by a control unit, by means of a sensor signal of the sensor.

The picking-up of the crop and the compressing of the bale can thus be characterized with the sensor signal of the sensor. In other words, providing a sensor signal which comprises a captured acoustic signal in the baler, in particular the baling unit, and/or an item of acoustic signal information, in the baler by a sensor and providing a sensor signal by the sensor and characterizing the picking-up of the crop and the compressing of a bale, in particular by a control unit, by means of the sensor signal of the sensor. The method has all the advantages and functions of the abovementioned combination according to the disclosure. Likewise, the method can comprise that an amplitude and/or a frequency of the sensor signal is identified and the picking-up and the compressing is characterized with the amplitude and/or a frequency of the sensor signal. Likewise, the amplitude and/or frequency of the sensor signal can be compared with a threshold value.

The sensor or sensors and/or the input and output unit and/or all the other sensors, and/or the PTO unit and/or the drive train, in particular the motor and/or the transmission unit and/or the transmission, can be operatable by means of the control unit, preferably be activatable and/or controllable and/or regulatable, particularly preferably settable and/or adjustable. The control unit can be assigned to the baler. Specifically, if the baler is part of a combination of a towing vehicle, for example a tractor or hauler, the control unit can be assigned to the towing vehicle or to the baler and the towing vehicle jointly and/or can be arranged on or in them. The combination, in particular the towing vehicle or the baler or both together, can comprise the control unit. The control unit can likewise be designed as a towing vehicle control unit and/or baler control unit.

The control unit can be designed as an electronic module, as an embedded system, as a calculating unit, as a computer, as a module for the control and/or regulation of the baler, preferably of the combination, i.e. of the towing vehicle and/or the baler. The control unit can comprise a processor, a memory and/or all the software, hardware, algorithms, connections, in particular also sensors, which are necessary for controlling and/or regulating the baler. The method can be designed as a program or algorithm which can be executed on and/or by means of the control unit. The control unit can comprise any device which can analyze data from different sensors, compare data, and make the necessary decisions in order to control and/or to regulate and/or to carry out the operation of the baler and the necessary tasks for controlling and/or regulating the operation of the baler.

The control unit can be connected to the components of the combination, i.e. in particular to the sensor and/or the input and output unit and/or all other sensors, and/or to the PTO unit and/or the drive train, in particular the motor and/or the transmission unit and/or the transmission, preferably in a manner connected by signals and/or transmitting signals and/or carrying data. A connection by signals and/or signal-transmitting and/or data-carrying connection can be understood here inter alia to mean that signals and/or data are exchanged between the connected components. Signals and/or data can, for example, be received and sent, and/or processed and/or manipulated, by the control unit. In other words, the control unit is configured to receive signals and/or data from the sensor and/or the input and output unit and/or all the other sensors and/or the PTO unit and/or the drive train, in particular the motor and/or the transmission unit and/or the transmission, and to send the signals/data to them. Likewise, the control unit can be configured to process and/or manipulate data and signals.

The connection between the control unit and the components of the baler, in particular of the combination, can be wired, i.e. in particular implemented by wire, and/or wirelessly, i.e. implemented by radio, for example by means of Bluetooth or WLAN. The communication bus can, for example, be Isobus, CAN bus, or similar. The control unit can be connected directly to the input and output unit which is arranged in a cab of the towing vehicle and by means of which data entered by an operator can be transmitted to the control unit or received from the control unit and output. It is, however, also conceivable that the control unit is connected indirectly to the input and output unit by a superordinate control unit. The control unit can be integrated into the input and output unit, or vice versa.

The above features and advantages and other features and advantages of the present teachings are readily apparent from the following detailed description of the best modes for carrying out the teachings when taken in connection with the accompanying drawings.

The above features and advantages and other features and advantages of the present teachings are readily apparent from the following detailed description of the best modes for carrying out the teachings when taken in connection with the accompanying drawings.

### BRIEF DESCRIPTION OF THE DRAWINGS

FIG. 1 is a schematic illustration of a baler according to the disclosure.

FIG. 2 is a schematic illustration of a first exemplary embodiment of a combination according to the disclosure.

FIG. 3 is a schematic flow chart of a method according to the disclosure.

FIG. 4 is a schematic illustration of a progression of the amplitude of the sensor signal during the picking-up of the crop and the compressing of the bale.

FIG. 5 is a schematic illustration of a progression of the frequency of the sensor signal during the picking-up of the crop and the compressing of the bale.

### DETAILED DESCRIPTION

Those having ordinary skill in the art will recognize that terms such as “above,” “below,” “upward,” “downward,” “top,” “bottom,” etc., are used descriptively for the figures, and do not represent limitations on the scope of the disclosure, as defined by the appended claims. Furthermore, the teachings may be described herein in terms of functional and/or logical block components and/or various processing steps. It should be realized that such block components may be comprised of any number of hardware, software, and/or firmware components configured to perform the specified functions.

The terms “forward”, “rearward”, “left”, and “right”, when used in connection with a moveable implement and/or components thereof are usually determined with reference to the direction of travel during operation, but should not be construed as limiting. The terms “longitudinal” and “transverse” are usually determined with reference to the fore-and-aft direction of the implement relative to the direction of travel during operation, and should also not be construed as limiting.

Terms of degree, such as “generally”, “substantially” or “approximately” are understood by those of ordinary skill to refer to reasonable ranges outside of a given value or orientation, for example, general tolerances or positional relationships associated with manufacturing, assembly, and use of the described embodiments.

As used herein, “e.g. ” is utilized to non-exhaustively list examples, and carries the same meaning as alternative illustrative phrases such as “including,” “including, but not limited to,” and “including without limitation. ” As used herein, unless otherwise limited or modified, lists with elements that are separated by conjunctive terms (e.g., “and”) and that are also preceded by the phrase “one or more of,” “at least one of,” “at least,” or a like phrase, indicate configurations or arrangements that potentially include individual elements of the list, or any combination thereof. For example, “at least one of A, B, and C” and “one or more of A, B, and C” each indicate the possibility of only A, only B, only C, or any combination of two or more of A, B, and C (A and B; A and C; B and C; or A, B, and C). As used herein, the singular forms “a”, “an” and “the” are intended to include the plural forms as well, unless the context clearly indicates otherwise. Further, “comprises,” “includes,” and like phrases are intended to specify the presence of stated features, steps, operations, elements, and/or components, but do not preclude the presence or addition of one or more other features, steps, operations, elements, components, and/or groups thereof.

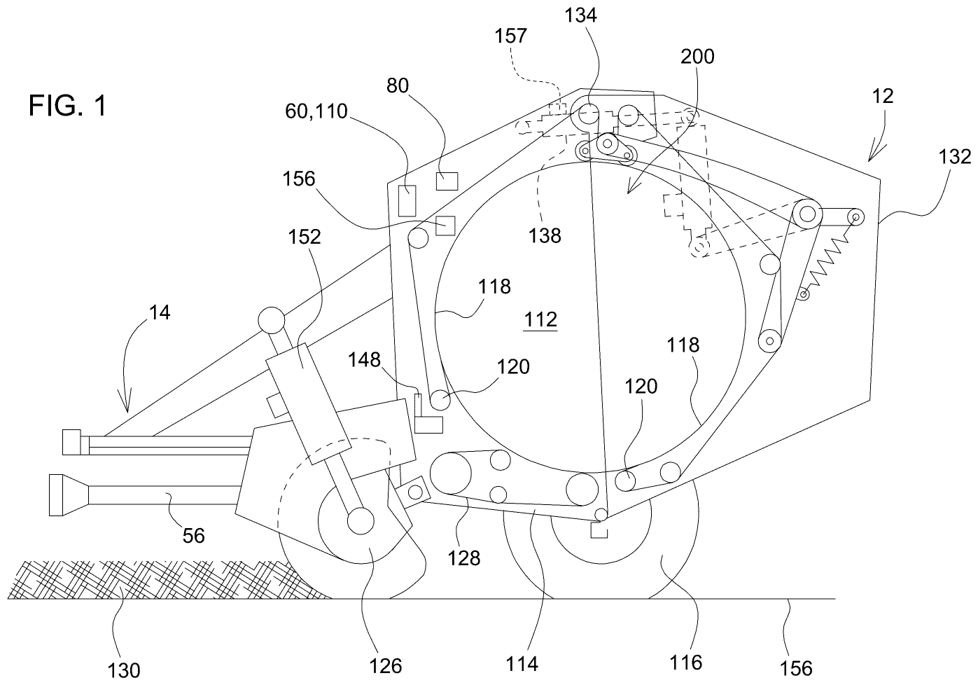

Referring to the Figures, wherein like numerals indicate like parts throughout the several views, FIG. 1 shows a schematic illustration of a baler 12 according to the disclosure. The baler 12 comprises a pick-up unit 126 for picking up a crop, and a baling unit 112 in order to shape or compress the picked-up crop into a bale 200. The baler 12 comprises a control unit 60. Alternatively, the baler 12 can comprise a baler control unit 110. The baler 12 can comprise a baler frame 114. The baler frame 114 can be supported on wheels 116. The baling unit 112 can be arranged at or on the baler frame 114, preferably connected to the latter and/or fastened to the latter and/or supported on the latter.

The baler 12 is designed with a variable-size baling unit 112. The baling means 118 is designed as a band or belt. The baling means 118 surrounds the baling unit 112 and is guided by rollers 120. However, the baler 12 can also be designed with an invariable-size baling unit 112. In this instance, the baling means 118 can be designed as one or a plurality of baling rollers, in particular a multiplicity of baling rollers running parallel to one another, for compressing the crop.

The pick-up unit 126, in particular in the form of a pick-up, is arranged on the baler 12 and/or connected thereto, in particular below the front edge of the baler 12. The pick-up unit 126 can comprise tines moving or rotating about a transverse axis. The pick-up unit 126 can be followed in a crop flow direction by a conveyor unit, in the present case a conveyor belt 128, of the baler 12. The conveyor belt 128 could also be replaced by a rotor (not shown), or a rotor could be inserted in the crop flow direction between the pick-up unit 126 and the conveyor belt 128. Instead of the pick-up unit 126, in particular the pickup, other suitable crop pick-up means, such as mowing and conveyor units, could also be used.

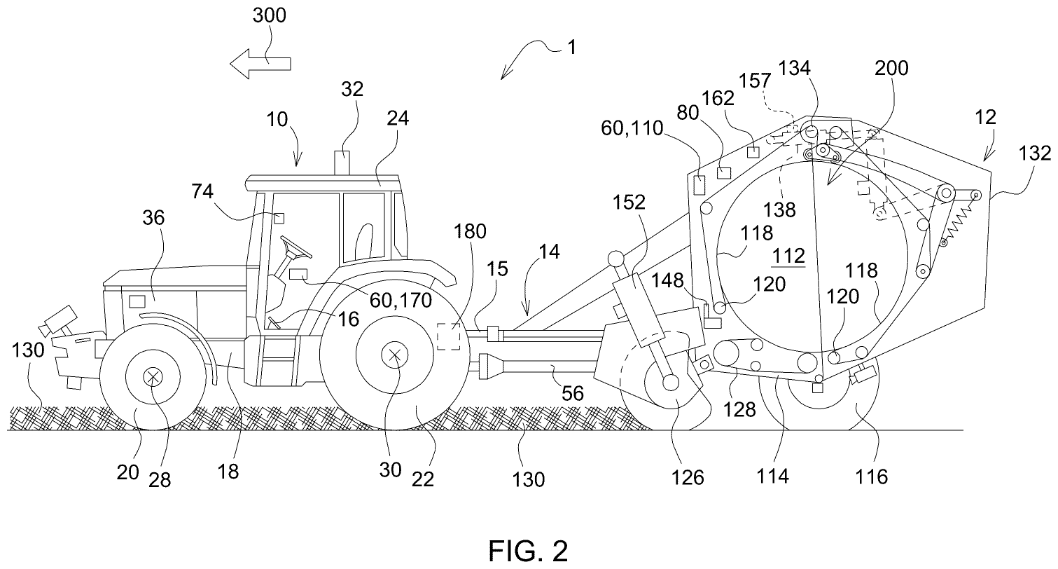

The pick-up unit 126 collects a crop that is lying in the field, in particular in a swath 130 of grass, hay, or straw, for example, and feeds it to the baling unit 112. The baling means 118, in particular one or a plurality of bands or straps, can be set in motion in the longitudinal direction thereof during a baling process by one or a plurality of the rollers 120 being rotatingly driven. The crop introduced into the baling unit 112 therefore also rotates during baling. During the baling process, the size, in particular the diameter, of the variable-size baling unit 112 increases over time. The baler 12 comprises an ejection unit 132, for example an ejection flap or a rear part or a rear flap of the baler. The ejection unit 132 is pivotably mounted on the baler 12, in particular on the baler frame 114 or on a housing part. The ejection unit 132 is pivotable about an axle 134 which extends transversely to the forward direction of a towing vehicle 10 (see FIG. 2) and/or of the baler 12. The ejection unit 132 can be moved between a first position, in which the baling unit 112 is closed, and a second position, in which the baling unit 112 is open for the purpose of discharging the bale. Moreover, the baler 12 can comprise a ramp in order to deposit the bale 200 on the ground 156.

The control unit 60 is connected to an actuator 138. The actuator 138 can be, for example, in the form of a pneumatic cylinder or lifting cushion or screw drive or rack and pinion drive or electric cylinder. In the present case, the actuator 138 is designed as a hydraulic cylinder. The control unit 60 can be connected to the actuator 138, in particular via a valve assembly 80, in particular a first valve assembly. The ejection unit 132 can be moved by means of the actuator 138 between the first position, in which the baling unit 112 is closed, and the second position, in which the baling unit 112 is open for the purpose of discharging the bale. The actuator 138 in the form of a hydraulic cylinder is connected, in particular pivotably fastened, at one end to the baler 12, for example to the baler frame 114 or the housing, and at a second end to the ejection unit 132. However, the ejection unit 132 can also be pivotably articulated, i.e. pivotably fastened at a pivot point. The actuator 138 can be connected to the ejection unit 132 in such a manner that it can pivot the ejection unit 132 upward about the axle 134 (counterclockwise in FIG. 1), thus enabling the bale 200 to be ejected from the baling unit 112. The ejection unit 132 can therefore be opened or closed or raised and lowered by means of the actuator 138. The actuator 138 can be set and/or adjusted, in particular controlled and regulated, by means of the control unit 60 by means of or via the valve assembly 80, for example, via an electromagnetic or hydraulic valve assembly. The valve assembly 80 can be set and/or adjusted, in particular controlled and regulated, by means of the control unit 60. An ejection flap sensor 157 can capture, for example, the position of the actuator 138 or of the ejection unit 132.

The baler 12 comprises a sensor 148 for capturing an acoustic signal. The sensor 148 is connected to the control unit 60 or the baler control unit 110, preferably by signals and/or connected thereto for transmitting signals and/or carrying data. The control unit 60 is configured to characterize the picking-up of the crop and the compressing of the bale on the basis of a sensor signal 300 of the sensor 148. The sensor 148 can thus interact with the baler 12 and capture and/or analyze the picking-up of the crop and the compressing of the bale. The sensor 148 can be arranged on the baling unit 112 and/or the pick-up unit 126 and/or the baler frame 114. The sensor 148 can be an acoustic sensor, in particular a microphone or an ultrasound sensor.

The pick-up unit 126 can be raised and lowered, for example by means of a further or second actuator 152, here in the form of a hydraulic cylinder. The further actuator 152 can be set and/or adjusted, in particular controlled and regulated, by means of the control unit 60, for example, via the valve assembly 80 or a further or second valve assembly (not illustrated). The further valve assembly can be, for example, a hydraulic or electromagnetic valve assembly. The further valve assembly can be set and/or adjusted, in particular controlled and regulated, by means of the control unit 60.

The control unit 60 or the baler control unit 110 can be configured to identify an amplitude and/or a frequency of the sensor signal 300 and to characterize the picking-up of the crop and/or the compressing of the bale of the baling unit 112 by means of the amplitude and/or the frequency. Moreover, the control unit 60 or the baler control unit 110 can be configured to compare the amplitude and/or the frequency of the sensor signal 300 with one or more threshold values. The acoustic signal can be capturable as a function of time and/or the control unit 60 or the baler control unit 110 can be configured to characterize the picking-up of the crop and/or the compressing of the bale on the basis of the sensor signal 300 of the sensor as a function of time. Alternatively or additionally, the control unit 60 or the baler control unit 110 can be configured to identify the amplitude and/or the frequency of the sensor signal 300 as a function of time and/or to compare the amplitude and/or frequency of the sensor signal 300 as a function of time with the threshold value or values. Moreover, the control unit 60 or the baler control unit 110 can be configured to filter and/or manipulate the sensor signal. Specifically, the control unit 60 or the baler control unit 110 can be configured to characterize, in particular to capture and/or identify, the picking-up of the crop and/or the compressing of the bale on the basis of a representative model as a function of the sensor signal 300 of the sensor 148.

FIG. 2 shows a schematic illustration of a first exemplary embodiment of a combination 1 according to the disclosure, comprising a towing vehicle 10 with a drive train 36 for driving the combination 1, in particular the towing vehicle 10, and a baler 12 according to the disclosure, in particular according to FIG. 1, pulled by the towing vehicle 10 by means of a drawbar 14. The baler 12 shown in FIG. 2 corresponds essentially to the baler 12 shown in FIG. 1 such that only details and/or differences are discussed below. The baler 12 shown in FIG. 1 can have the additional features and properties described below.

The combination 1 comprises a towing vehicle 10 and the baler 12, which is pulled by the towing vehicle 10 by means of a drawbar 14. The towing vehicle 10 comprises a drive train 36 which can be connected to a drive shaft 56 of the baler 12. The towing vehicle 10, in particular the drive train 36, comprises a motor 38, for example an internal combustion engine or an electric motor. The towing vehicle 10, in particular the drive train 36, can moreover comprise a transmission unit 40, in particular a transmission. The motor 38 can moreover be mechanically connected directly or indirectly to an input shaft of the drive unit 56 of the baler 12.

The combination 1 or the towing vehicle 10 comprises the input and output unit 74. The control unit 60 can also be arranged in the towing vehicle 10. Likewise, the control unit 60 can, however, also be designed as a towing vehicle control unit 170 and baler control unit 110, wherein the baler 12 can comprise the baler control unit 110 and the towing vehicle 10 can comprise the towing vehicle control unit 170. The baler control unit 110 and the towing vehicle control unit 170 can each be designed individually as a control unit 60 or can jointly have the structure and all the functionalities and all the connections of the control unit 60. The control unit 60 is connected to input and output unit 74, preferably by signals and/or connected thereto for transmitting signals and/or carrying data. By means of the input and output unit 74 arranged in a cab 24 of the towing vehicle, data or commands entered into the input and output unit 74 by an operator of the combination 1 can be transmitted to or received from the control unit 60. The data and commands can be output by means of the input and output unit 74.

The towing vehicle 10 can comprise a towing vehicle frame 18, in particular can be supported on the towing vehicle frame 18. The towing vehicle frame 18 can be supported on ground engagement means. The ground engagement means, illustrated here in the form of front wheels 20 and rear wheels 22, are in engagement with an underlying surface in order to transmit driving forces, and/or the towing vehicle 10 is supported by these means on the underlying surface. The ground engagement means, in particular the front wheels 20 and rear wheels 22, can be steerable and/or movable. The cab 24 can be supported by the towing vehicle frame 18. Moreover, an operator's workstation and/or the input and output unit 74 can be situated in the cab 24. The towing vehicle 10 comprises a front axle 28 and a rear axle 30. The rear axle 30 can be permanently driven, and the front axle 28 can be entirely undriven or activatable on demand or permanently driven. The front axle 28 and/or in particular the rear axle 30 can be steerable. The towing vehicle 10 can also comprise, for example, an accelerator pedal 16 or a hand throttle lever not shown. Directional specifications, such as front and rear, left and right, hereunder refer to the forward direction 300 of the towing vehicle 10, which forward direction goes to the left in FIG. 1.

The baler 12 is connected, and/or in particular coupled, to the towing vehicle 10. The towing vehicle 10 is connected to the baler 12 by the drawbar 14. For example, the baler 12 can be coupled to a hitch 15 of the towing vehicle 10 by means of the drawbar 14. The towing vehicle 10 can pull the baler 12. The towing vehicle 10 can comprise a PTO unit 180. The PTO unit 180 can comprise in particular a PTO transmission 182 and/or a PTO shaft 184. The PTO unit 180 can be drivable by means of the drive train 36, in particular the motor 82 and/or the transmission unit 84. The PTO unit 180 can be mechanically connected to the baler 12 to drive the baling unit 112 and the pick-up unit 126.

The control unit 60 or the baler control unit 110 or the towing vehicle control unit 170 can be configured to generate and/or send a pick-up signal and/or a compressing signal as a function of the sensor signal 300. The control unit 60 or the towing vehicle control unit 170 can be configured to activate the input and output unit 74 by means of or based on the pick-up signal and/or the compressing signal. The input and output unit 74 can be configured to signal to the operator by means of or based on the pick-up signal and/or the compressing signal that the baler 12 is in a picking-up phase or a compressing phase. Specifically, the baler control unit 110 or the control unit 60 can be configured to signal to the operator by means of or based on the pick-up signal and/or the compressing signal that the bale 200 has been completely formed.

Furthermore, the control unit 60 or the baler control unit 110 or the towing vehicle control unit 170 can be configured to generate and/or send a driving signal and/or a control signal as a function of the sensor signal 300, in particular as a function of the amplitude and/or the number of amplitudes and/or the frequency. The control unit 60 or the baler control unit 110 or the towing vehicle control unit 170 can be configured to set and/or adjust a speed of the combination 1, in particular the drive train 36, by means of the driving signal and/or to set and/or adjust the PTO unit 180 by means of the control signal. The control unit 60 or the baler control unit 110 or the towing vehicle control unit 170 can be configured to activate and/or set and/or adjust the drive train 36 by means of the driving signal in such a way that a rotational speed and/or a torque and/or an energy of the drive train 36 is increased or reduced. The control unit 60 or the towing vehicle control unit 170 can be configured to activate the input and output unit 74 by means of or based on the driving signal, such that the input and output unit 74 signals to the operator to change a speed of the towing vehicle 12, or the input and output unit 74 is configured to signal to the operator to change a speed of the towing vehicle 12.

The control unit 60 or the baler control unit 110 or the towing vehicle control unit 170 can be configured to activate and/or set and/or adjust the PTO unit 180 by means of the control signal in such a way that a rotational speed and/or a torque and/or an energy of the PTO unit 180 is increased or reduced.

The control unit 60 or the towing vehicle control unit 170 can be configured to activate the input and output unit 74 by means of or based on the control signal, such that the input and output unit 74 signals to the operator to change the rotational speed and/or a torque and/or an energy of the PTO unit.

The combination 1, in particular the towing vehicle 10, can also comprise a GPS device 32 for determining the position of the combination 1 in the form of a position signal. The control unit 60 is connected to the GPS device 32. The control unit 60 receives the position signal from the GPS device 32. The control unit 60 can be operated in such a way that a discharging angle and/or a discharging position can be determined and/or obtained by means of the control unit 60 as a function of the position signal. Thus, position data can be be sendable and/or receivable, and/or in particular calculatable, by means of the GPS device 32. The GPS device 32 can comprise, for example, a GPS antenna receiving position data, and a memory. The position of the swath 130 which is known from earlier jobs can be stored in the memory. The towing vehicle 10 can then be steered in such a manner that the actual position of the combination 1 or of the towing vehicle 10, which is provided by the GPS antenna, and the position of the swath 130 from the memory coincide.

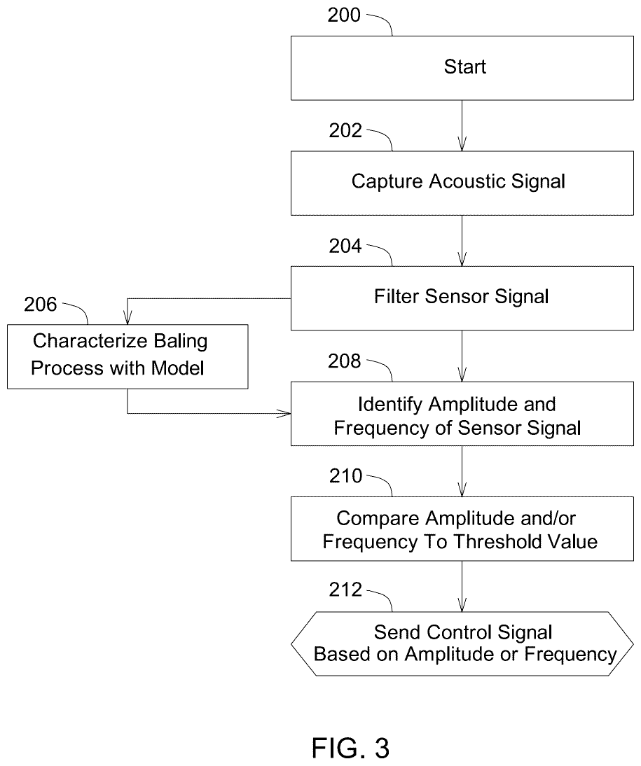

FIG. 3 shows a schematic flow chart of the method according to the disclosure, in particular showing how the control unit 60 operates and the sequence of the method. The operation shown in FIG. 2 can be carried out with the baler 12 shown in FIG. 1, wherein only the details and/or differences from FIG. 1 are discussed below.

After the start in step 200, there follows the step 202 in which an acoustic signal at or in the baler 12 is captured by means of the sensor 148. The baling process, i.e. the picking-up of the crop and/or the compressing of the bale, can thus be characterized on the basis of a sensor signal 300 of the sensor 148. In particular, the control unit can be configured to identify an amplitude and/or a frequency of the sensor signal 300 and to characterize the picking-up of the crop and/or the compressing of the bale by means of the amplitude and/or the frequency. Specifically, the acoustic signal can be capturable as a function of time. The term “characterized” can be understood to mean that the baling process is captured and/or reproduced by the sensor signals, in particular by the sensor signals as a function of time.

In an optional step 204, the sensor signal, in particular the sensor signals as a function of time, can be filtered and/or processed, in particular the amplitude thereof can be changed. Specifically, the sensor signal, in particular the sensor signals as a function of time, can be processed with a Fourier transform and/or a high-pass filter and/or a low-pass filter can be applied to the signals or the Fourier transform thereof.

In an optional step 206, the baling process can be characterized on the basis of a model which represents the baling process, in particular the picking-up of the crop and/or the compressing of the bale, as a function of the sensor signal of the sensor, in particular of the sensor signals as a function of time. In this case, the model may be a software depiction or simulation or a function of the wrapping operation. By means of a compensation calculation, the parameters of the function can be determined or estimated.

In an optional step 208, the amplitudes and/or the frequencies of the sensor signal 300, in particular the sensor signals as a function of time, and/or the amplitudes of the Fourier transform of the sensor signal 300, in particular the sensor signals as a function of time, can be identified. Likewise, the amplitudes and/or frequencies can be identified on the basis of the model representing the baling process.

In a further optional step 210, the amplitude and/or frequencies of the sensor signal 300, in particular the amplitudes and/or frequencies of the sensor signal 300 as a function of time, and/or the amplitudes and/or frequencies of the model representing the wrapping process, can be compared with one or more threshold values.

In a further step 212, the control unit 60 can be configured to generate and/or send a pick-up signal and/or a compressing signal as a function of the sensor signal 300. Alternatively or additionally, the control unit 60 can be configured to generate and/or send a driving signal and/or a control signal as a function of the sensor signal 300, in particular of the amplitude 304 and/or the frequency, in particular to set and/or adjust the drive train and/or the PTO unit as described above.

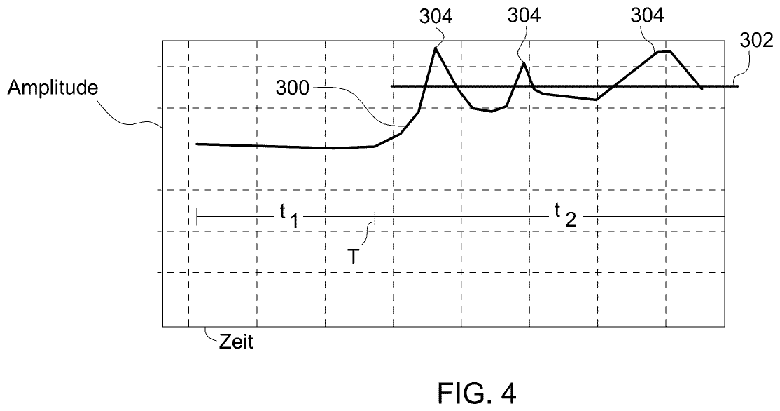

FIG. 4 shows a schematic illustration of the progression of the amplitude of the sensor signal 300 during the picking-up and the compressing of the crop, i.e. in particular during the baling process. The sensor signal 300 shown in FIG. 4 corresponds essentially to the sensor signal 300 shown in FIGS. 1 to 3, such that only details and/or differences are discussed below. Time is plotted on the abscissa, i.e. the x-axis, and the amplitude of the sensor signal is plotted on the ordinate, i.e. the y-axis. The sensor signal 300 shown can be the sensor signal 300 of the sensor 148, in particular the sensor signal 300 as a function of time or the representative model. In a time period t1, the sensor signal 300, in particular the amplitude 304, is below the threshold value 302. For example, only the sound which is caused, for example, by vibrations, in particular of the baler 12 or by picking up the crop can be captured. If the amplitude 304 is below the threshold value, either the pick-up signal and/or the driving signal and/or the control signal are generated and sent. Alternatively, if the amplitude 304 is below the threshold value 302, the compressing signal and/or the driving signal and/or the control signal can be generated and sent. After the time T, a further time period t2 to which the compressing of the bale corresponds begins. After this time T, the amplitude 304 of the sensor signal 300 rises. The amplitudes 304 are above the threshold value 302. If the amplitude 304 is above the threshold value 302, either the pick-up signal and/or the driving signal and/or the control signal can be generated and sent. Alternatively, if the amplitude 304 is above the threshold value 302, the compressing signal and/or the driving signal and/or the control signal can be generated and sent.

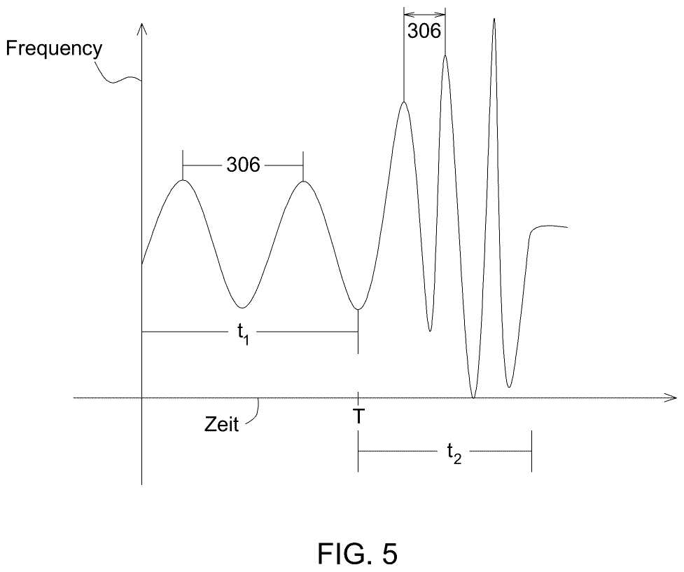

FIG. 5 shows a schematic illustration of the progression of the frequency 306 of the sensor signal 300 during the picking-up and the compressing of the crop, i.e. in particular during the baling process. The sensor signal 300 shown in FIG. 5 corresponds essentially to the sensor signal 300 shown in FIGS. 1 to 4, such that only details and/or differences are discussed below. Time is plotted on the abscissa, i.e. the x-axis, and the amplitude of the sensor signal is plotted on the ordinate, i.e. the y-axis. The sensor signal 300 shown can be the sensor signal 300 of the sensor 148, in particular the sensor signal 300 as a function of time or the representative model. The frequency 306 can here be a result of the cycle duration. In a time period t1, the sensor signal 300, in particular the frequency 306, is below the threshold value, in particular the frequency threshold value. If the frequency 306 is below the threshold value, either the pick-up signal and/or the driving signal and/or the control signal can be generated and sent. Alternatively, if the frequency 306 is below the threshold value, the compressing signal and/or the driving signal and/or the control signal can be generated and sent. After the time T, a further time period t2 to which the compressing of the bale corresponds begins. After this time T, the frequency 306 of the sensor signal 300 rises. The frequency 306 is above the threshold value. If the frequency 306 is above the threshold value, either the pick-up signal and/or the driving signal and/or the control signal can be generated and sent. Alternatively, if the frequency 306 is above the threshold value, the compressing signal and/or the driving signal and/or the control signal can be generated and sent.

The detailed description and the drawings or figures are supportive and descriptive of the disclosure, but the scope of the disclosure is defined solely by the claims. While some of the best modes and other embodiments for carrying out the claimed teachings have been described in detail, various alternative designs and embodiments exist for practicing the disclosure defined in the appended claims.

What is claimed is:

1. A baling combination comprising:
a tow vehicle;
a baler including a pick-up unit configured for picking up a crop from a ground surface and for feeding the crop into a baling unit, wherein the baling unit is configured for receiving the crop from the pick-up unit and for compressing the crop into a bale;
a sensor configured for capturing an acoustic signal from the baler and generating a sensor signal indicative thereof; and
a control unit connected to the sensor, wherein the control unit is configured to characterize the picking-up of the crop and the compressing of the crop into the bale based on the sensor signal from the sensor.

2. The baling combination set forth in claim 1, wherein the control unit is configured to identify at least one of an amplitude and a frequency of the sensor signal and to characterize the picking-up of the crop or the compressing of the bale based on at least one of the amplitude and the frequency.

3. The baling combination set forth in claim 2, wherein the control unit is configured to compare the at least one of the amplitude and the frequency of the sensor signal to a threshold value.

4. The baling combination set forth in claim 3, wherein the acoustic signal can be captured as a function of time and the control unit is configured to characterize the picking-up of the crop or the compressing of the bale on the basis of the sensor signal of the sensor as a function of time.

5. The baling combination set forth in claim 4, wherein the acoustic signal can be captured as a function of time and the control unit is configured to identify the at least one of the amplitude and the frequency of the sensor signal as a function of time and to compare the at least one of the amplitude and the frequency of the sensor signal as a function of time with the threshold value.

6. The baling combination set forth in claim 1, wherein the control unit is configured to filter or manipulate the sensor signal.

7. The baling combination set forth in claim 1, wherein the control unit is configured to generate and send one of a pick-up signal or a compressing signal as a function of the sensor signal.

8. The baling combination set forth in claim 1, wherein the control unit is configured to generate and send at least one of a driving signal or a control signal as a function of the sensor signal, in particular as a function of the amplitude and the frequency.

9. The baling combination set forth in claim 8, wherein the towing vehicle comprises a drive train for driving the towing vehicle, and wherein the control unit is connected to the drive train and configured to set or adjust a speed of the combination, in particular the drive train, by means of the driving signal.

10. The baling combination set forth in claim 8, wherein the towing vehicle comprises a PTO unit, and wherein the control unit is connected to the PTO unit and configured to set or adjust a speed of the PTO unit by means of the control signal.

11. The baling combination set forth in claim 1, wherein the sensor is arranged on one of the baling unit, the pick-up unit, or a baler frame of the baler.

12. The baling combination set forth in claim 1, wherein the sensor is an acoustic sensor, in particular a microphone or an ultrasound sensor.

13. The baling combination set forth in claim 1, wherein the control unit is configured to characterize, in particular to capture and identify, the picking-up of the crop or the compressing of the bale on the basis of a representative model as a function of the sensor signal of the sensor.

14. A baler comprising:
a pick-up unit configured for picking up a crop from a ground surface;
a baling unit configured for receiving the crop from the pick-up unit and for compressing the crop into a bale;
a sensor configured for capturing an acoustic signal emitted from the baler and generating a sensor signal indicative thereof;
a control unit in communication with the sensor for receiving the sensor signal therefrom, and including a processor and a memory having an algorithm stored thereon, wherein the processor is operable to execute the algorithm to:
characterize operation of at least one of the pick-up unit picking-up of the crop or operation of the baling unit compressing of the crop into the bale based on the sensor signal from the sensor;
communicate one of a pick-up signal to the pick-up or a compressing signal to the baling unit based on the characterized operation of the pick-up or the characterized operation of the baling unit to adjust operation thereof.

15. The baler set forth in claim 14, wherein the processor is operable to execute the algorithm to identify at least one of an amplitude and a frequency of the sensor signal and to characterize the picking-up of the crop or the compressing of the bale based on at least one of the amplitude and the frequency.

16. The baler set forth in claim 15, wherein the processor is operable to execute the algorithm to compare the at least one of the amplitude and the frequency of the sensor signal to a threshold value.

17. The baler set forth in claim 16, wherein the acoustic signal can be captured as a function of time and the processor is operable to execute the algorithm to identify the at least one of the amplitude and the frequency of the sensor signal as a function of time and to compare the at least one of the amplitude and the frequency of the sensor signal as a function of time with the threshold value.

18. The baler set forth in claim 14, wherein the processor is operable to execute the algorithm to generate and send a driving signal to a towing vehicle to adjust operation of a drivetrain of the towing vehicle based on the characterized operation of the pick-up or the characterized operation of the baling unit.

19. The baler set forth in claim 14, wherein the processor is operable to execute the algorithm to generate and send a PTO control signal to a towing vehicle based on the characterized operation of the pick-up or the characterized operation of the baling unit to adjust operation pf a PTO unit of the towing vehicle.

20. The baler set forth in claim 14, wherein the sensor is an acoustic sensor, in particular a microphone or an ultrasound sensor.
